(19) United States
(12) Patent Application Publication
(10) Pub. No.: US 2009/0000128 A1
(43) Pub. Date: Jan. 1, 2009

(54) Hand-Guided Power Tool with a Cooling Apparatus

(76) Inventors: Hans Kaiser, Leuzigen (CH); Stefano Delfini, Bettlach (CH); Michael Huber, Hohenau (DE); Martin Affolter, Arch (CH)

Correspondence Address: MICHAEL J. STRIKER, 103 EAST NECK ROAD, HUNTINGTON, NY, 11743, US

(21) Appl. No.: 12/160,273

(22) PCT Filed: May 4, 2007
(86) PCT No.: PCT/EP2007/054363

§ 371 Date: Jul. 8, 2008

(30) Foreign Application Priority Data
Jun. 28, 2006 (DE) 10 2006 029 634.6

(51) Int. Cl. B27B 19/09

(52) U.S. Cl. 30/166.3

(57) ABSTRACT

A portable electric power tool is specified, having a metal housing (10), at least a region of which is covered with at least one plastic part (26, 27). To cool that region of the metal housing (10) which gets very warm due to the plastic cover, means are provided which produce Can air flow (28) which is supplied from outside and sweeps over the metal housing (10) in the region of the plastic part (26).

### PRIOR ART

The invention is based on a hand-guided power tool according to the preamble to claim 1.

Known hand-guided power tools, e.g. jigsaws, have a metal housing that is in particular embodied in the form of a die cast housing. The metal housing includes a transmission housing and attached motor housing with an integrated electric motor whose driven shaft constitutes the input shaft of the transmission. The heat generated during operation of the hand-guided power tool is dissipated by means of dissipation surfaces of the metal housing. In order to be able to handle the machine despite intense heating of the metal housing, at least the grip regions of the metal housing are covered with a plastic part that functions as a heat insulator and assures that it is safe to touch and hold the hand-guided power tool. The encapsulation of housing regions of the metal housing with a plastic part, however, sharply increases the temperature in these regions of the machine due to the heat-insulating action of the plastic part.

### DISCLOSURE OF THE INVENTION

The hand-guided power tool according to the invention, with the defining characteristics of claim 1, has the advantage that cold outside air is guided over the region of the metal housing encapsulated with the plastic part and absorbs a large part of the heat, preferably conveying it back to the outside along with the motor-cooling airflow. The large temperature difference between the outside air and the heated metal housing, combined with the low airflow speed in the intake region, makes it possible for the colder outside air to absorb a great deal of heat, thus achieving an effective cooling of the encapsulated metal housing regions and reducing the temperature of the metal housing as a whole during operation. The improved cooling not only improves the handling of the hand-guided power tool, but also extends its service life.

Advantageous modifications and improvements of the hand-guided power tool disclosed in claim 1 are possible by means of the steps taken in the remaining claims.

According to an advantageous embodiment of the invention, the means for generating the airflow in the plastic-encapsulated housing region have an air intake opening in the plastic part and an air conduit whose one end remote from the air outlet opening is connected to a cavity, which is provided between the metal housing and the plastic part, and whose other end feeds into the cooling airflow for an integrated electric motor. Through appropriate dimensioning of the air conduit, the outside air that is drawn across the region of the metal housing encapsulated by the plastic part is dimensioned so that the cooling air quantity flowing through the electric motor is only reduced to an extent that continues to assure a sufficient cooling of the motor. Preferably, the opening of the air conduit that feeds into the cooling airflow is situated directly at the air intake side of a fan impeller supported on the driven shaft of the motor. The air conduit can alternatively be embodied as a separate component or be integrated into the metal housing and/or the plastic part.

According to an advantageous embodiment of the invention, the air intake opening is situated in the plastic part in the vicinity of the most powerfully heated region of the part of the metal housing covered by the plastic part. This structural measure achieves the greatest possible cooling effect.

### BRIEF DESCRIPTION OF THE DRAWINGS

The invention will be explained in greater detail in the description below in conjunction with an exemplary embodiment shown in the drawings.

FIG. 1 is a side view of a hand-guided power hacksaw,

FIG. 2 shows details of an exploded depiction of the hand-guided power hacksaw from FIG. 1, and

FIG. 3 shows a detail of a partial longitudinal section through the hand-guided power hacksaw from FIG. 1.

### EMBODIMENT OF THE INVENTION

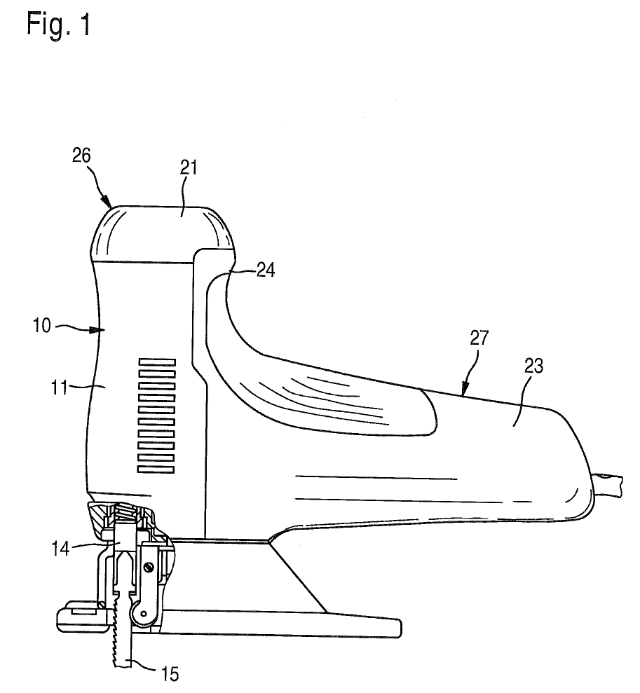

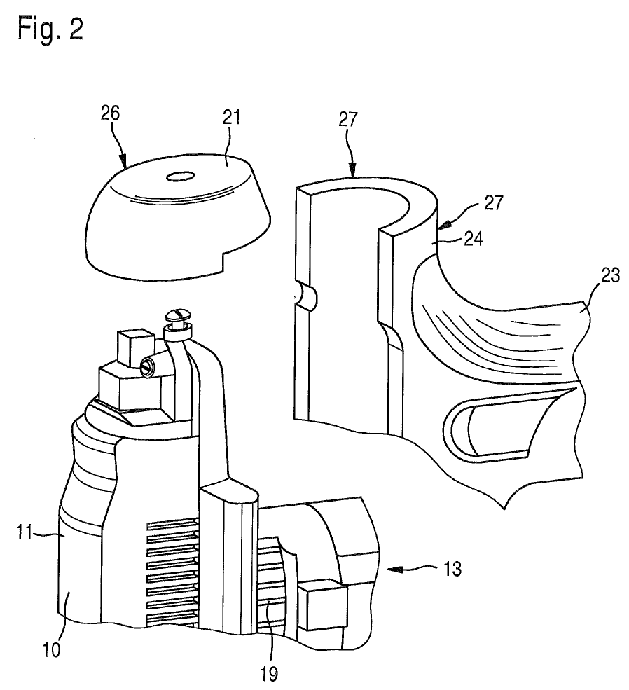

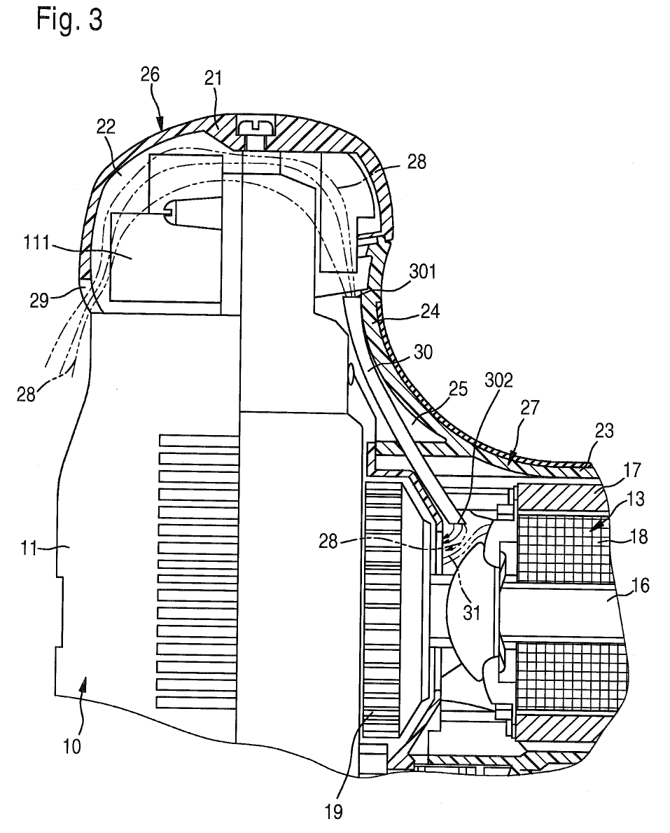

The hand-guided power hacksaw, also referred to as a jigsaw, which is shown in a side view in FIG. 1 and in a detailed exploded view in FIG. 2 and serves here as an exemplary embodiment of a general hand-guided power tool, has a metal housing 10 that is comprised in this case by a transmission housing 11 composed of two parts. Preferably, the metal housing 10 is a die cast housing. An electric motor 13 with a driven shaft 16 is preferably situated at right angles to the transmission housing 11. The driven shaft 16 of the electric motor 13 constitutes the input shaft of a transmission, not shown here, that is accommodated in the transmission housing 11 and serves as a reciprocating drive mechanism for a reciprocating piston 14 into which a jigsaw blade 15 is clamped. The electric motor 13 that is partially depicted in FIG. 3 is equipped in a known fashion with a stator 17 and a rotor 18 with a driven shaft 16. The driven shaft 16 supports a fan impeller 19, which, with the rotation of the rotor 18, draws cooling air through the electric motor 13; the cooling air, which is heated as it passes to the electric motor 13, is blown out again via air outlet openings not shown here. The cooling airflow 29 is symbolized by flow arrows in FIG. 3.

Since the metal housing 10 heats up intensely during operation of the hand-guided power tool, regions of the metal housing 10 that the operator grasps or touches are encapsulated or covered with a plastic part in order to assure safe handling of the machine. The plastic parts function as heat insulators and prevent the operator from coming into contact with the hot metal housing 10 while using the hand-guided power tool. In the present exemplary embodiment of the hand-guided power hacksaw, the housing head 111 of the transmission housing 11 is covered with a plastic part 26, while the electric motor 13 is accommodated in a plastic part 27 embodied in the form of a housing cup 23, which, in the exemplary embodiment shown, is simultaneously designed to serve as a grip for holding and guiding the hand-held power hacksaw. The plastic parts 26, 27 are shown in a perspective, detailed view in FIG. 2. The one plastic part 26 is a plastic cap 21 that is placed onto the housing head 111 of the transmission housing 11; a cavity 22 remains between the housing head 111 and the plastic cap 21, as shown in the sectional view in FIG. 3. In the exemplary embodiment, the plastic cap 21 placed onto the housing head 111 of the transmission housing 11 constitutes a mushroom-shaped auxiliary grip for two-handed guidance of the hand-guided power hacksaw. The housing cup 23 constituting the other plastic part 27 has an integral collar 24 extending from the edge of the housing cup 23. The collar 24 partially embraces the transmission housing 11, extends up to the plastic cap 21, and snugly adjoins the rear side of the plastic cap 21 oriented toward the housing cup 23. Another cavity 25 is provided between the collar 24 and the transmission housing 11 and extends in uninterrupted fashion to the cavity 22.

The partial covering of the transmission housing 11 by the plastic cap 21 and the collar 24 of the plastic part 27 sharply increases the temperature in the metal housing 10 due to the heat-insulating character of the plastic parts 26, 27. In order to counteract this, means must be provided for generating a “cold” airflow 28, which comes directly from the outside and not via the electric motor 13, sweeping across the region of the metal housing 10 covered by the plastic cap 21, i.e. the housing head 111, thus drawing heat from the metal housing 10. In FIG. 3, the airflow 28 is indicated by means of flow arrows. The means for generating the airflow 28 include an air intake opening 29 and an air conduit 30. The air intake opening 29 is situated in the vicinity of the most intensely heated region of the housing head 111 of the transmission housing 11 covered by the plastic cap 21, in this case at the front, lower cap edge of the plastic cap 21. In the exemplary embodiment shown, the air conduit 30 is placed as a separate part and assembly component into the cavity 25 formed between the collar 24 of the plastic part 27 and the transmission housing 11. The air conduit 30 in this case is positioned so that an opening 301 of its one conduit end is situated at the end of the cavity 22 oriented away from the air intake opening 29 and therefore, the “cold” outside air flowing in through the air intake opening 29 sweeps across the largest possible portion of the housing head 111 before traveling into the opening 301 of the air conduit 30. The opening 302 of the other conduit end of the air conduit 30 feeds into the cooling airflow 31 of the motor cooling air drawn in by the fan impeller 19. In this case, the opening 302 of the air conduit 30 oriented toward the cooling airflow is situated directly at the intake side of the fan impeller 19. This produces a suction action, the so-called Venturi effect. The air conduit 30 is dimensioned so that the additional outside air drawn in through the air intake opening 29 only reduces the cooling airflow 31 drawn through the electric motor 13 by the fan impeller 19 to an extent that the cooling airflow 31 continues to assure a sufficient dissipation of the heat generated in the electric motor 13.

Due to the large temperature difference between the incoming “cold” outside air and the hot housing head 111, the outside air drawn through the air intake opening 29 by the rotation of the fan impeller 19 absorbs a great deal of heat and conveys it out, thus significantly reducing the temperature in the cavity 22 and in the housing head 111. The powerfully heated outside air conveyed via the air conduit 30 to the intake side of the fan impeller 19, together with the cooling air that has been heated by the electric motor 13, is conveyed out via the air outlet openings between the transmission housing 11 and the housing cup 23. The air outlet openings on the transmission housing 11 are advantageously provided with cooling fins so that the dissipation area of the hot air is as large as possible.

The air conduit 30 is not necessarily a separate part and assembly component placed into the cavity 25. It can also be incorporated into the transmission housing 22 and/or into the collar 24 of the plastic part 27. The hand-guided power hacksaw in the above-described exemplary embodiment is embodied in the form of a so-called “barrel grip machine” with a cup construction. The additional cooling according to the invention can, however, also be advantageously used in hand-guided power hacksaws embodied in a top handle design with a cup construction, a shell construction, or a combination thereof.

What is claimed is:

1. A hand-guided power tool with a metal housing (11) that is at least partially covered with at least one plastic part (26, 27),
wherein means are provided for generating an airflow (28) that is supplied from the outside and sweeps across the metal housing (10) in the region of the plastic part (26).

2. The hand-guided power tool as recited in claim 1,
wherein the means for generating the airflow (28) have an air intake opening (29) in the plastic part (26) and an air conduit (30) whose one end connects to a cavity (22), which is provided
between the metal housing (10) and the plastic part (26), at the end of the cavity remote from the air intake opening (29), and whose other end feeds into the cooling airflow (31) for an integrated electric motor (13).

3. The hand-guided power tool as recited in claim 2,
wherein the electric motor (13) drives a fan impeller (19) in order to generate the cooling airflow (31) and the opening (302) of the air conduit (30) that feeds into the cooling airflow (31) is situated directly at the air intake side of the fan impeller (19).

4. The hand-guided power tool as recited in claim 2,
wherein the air intake opening (29) in the plastic part is situated in the vicinity of the most intensely heated region of the metal housing (10) covered by the plastic part (26).

5. The hand-guided power tool as recited in claim 2,
wherein the air conduit (30) is a separate part and assembly component that is situated between the plastic part (27) and the metal housing (10).

6. The hand-guided power tool as recited in claim 2,
wherein the air conduit (30) is at least partially formed into the metal housing (10) and/or the plastic part (26, 27).

7. The hand-guided power tool as recited in claim 4,
wherein the metal housing (10) has a housing head (111) that is covered by a plastic part (26) and the air entry opening (25) in the plastic part (26) and the opening (301) of the air conduit (30) that opens into the cavity are situated at diametrically opposed positions on the cap edge of the plastic cap (21).

8. The hand-guided power tool as recited in claim 7,
wherein the electric motor (13) is accommodated in a plastic part (27) that has a collar (24) formed onto it, which partially embraces the metal housing (10) and extends up to the cap edge of the plastic cap (21), and the air conduit (30) is situated in a cavity (25) that is provided between the metal housing (10) and the collar (24).
